(19) United States
(12) Patent Application Publication
(10) Pub. No.: US 2021/0060507 A1
(43) Pub. Date: Mar. 4, 2021

(54) INSTALLATION AND METHOD FOR PRODUCTION OF NANOPOWDERS

(71) Applicant: Mikromasch Eesti OÜ, Tallinn (EE)

(72) Inventors: Dmitrii Semenenko, Odincovo (RU); Pavel Boltyshov, Moscow (RU); Denis Shabratov, Moscow (RU)

(73) Assignee: Mikromasch Eesti OÜ, Tallinn (EE)

(21) Appl. No.: 17/005,524

(22) Filed: Aug. 28, 2020

Related U.S. Application Data
(60) Provisional application No. 62/893,243, filed on Aug. 29, 2019.
(60) Provisional application No. 62/893,252, filed on Aug. 29, 2019.

(51) Int. Cl. B01J 6/00; C01B 25/45

(52) U.S. Cl. CPC B01J 6/008; C01P 2004/64; C01B 25/45

(57) ABSTRACT

An installation and method for production of nanopowders by spray pyrolysis by capture, grind, and temperature exposure of nanoparticles, wherein efficiency of particle retention in the cyclone in the suspended state is achieved.

### TECHNICAL FIELD

The present disclosure relates to technologies and devices for the production of nanoparticles, namely, to the design of devices used for the capture, collection and temperature treatment of nanoparticles of different sizes and for the synthesis of nanoparticles by liquid-phase flame spray pyrolysis.

### BACKGROUND

The problem of producing nanopowders is that the known reaction modules do not allow industrial production of nanopowders, the production efficiency is very low and the maintenance is complicated.

Therefore, there exists a need to overcome the aforementioned drawbacks associated with the conventional systems for producing nanopowders.

### SUMMARY

The aim of the present disclosure is to provide an apparatus, assembly and method to improve the performance of the plant to obtain nanopowders.

The aim of the disclosure is achieved by an assembly and/or apparatus comprising a modular installation of the nanopowder production plant and a plurality of reactors with a common output.

In an embodiment, an assembly for the production of nanopowders by spray pyrolysis, comprises

a modular system having at least three reaction modules;

a propane burner installed at the entrance of the modular system; and

a spray system at some distance from the entrance to a reactor of the modular system for inserting an aerosol of the aqueous solution of the precursor.

An advantage of the present disclosure is that it allows to establish industrial production of nanopowders of any powder, using standard reaction modules.

The aim of the present disclosure is to provide a method for thermal processing and grinding of nanopowders by capture, grind, temperature exposure of nanoparticles with particle size up to 1 μm in a suspended state, which avoids the formation of nanomaterial sinters, as well as separation and collection of large non-grinding particles of the material.

Another embodiment the present disclosure provides a method for thermal processing and grinding of nanopowders comprising steps of: spraying a solution in a zone of a reactor of a cyclone; carrying out evaporation of the solution, particle formation, precursor and decomposition or chemical reaction of the particle precursor and the crystallization of nanopowders.

### BRIEF DESCRIPTION OF THE DRAWING

Embodiments of the present disclosure will now be described, by way of example only, with reference to the following diagrams wherein:

FIG. 1 is a schematic illustration of a system according to an embodiment of the present disclosure.

### DETAILED DESCRIPTION OF EMBODIMENTS

The following detailed description illustrates embodiments of the present disclosure and ways in which they can be implemented. In one aspect, an embodiment of the present disclosure provides an assembly for the production of nanopowders by spray pyrolysis. In one embodiment, the assembly comprises

a modular system having at least three reaction modules;

a propane burner installed at the entrance of the modular system; and

a spray system at some distance from the entrance to a reactor of the modular system for inserting an aerosol of the aqueous solution of the precursor into the reactor.

Further, the reaction module of the assembly is a cylindrical reactor.

The modular system comprises at least a heat generator section, a reactor section and a product formation chamber.

The nozzle is at an angle of 45 degrees with respect to the reaction module.

The length of the pipe of the nozzle is 1.5-2 times a diameter of the reaction section.

The spray system or device comprises a mist-type two-phase nozzle with a spray cone angle of 30 degrees, a pump for pumping the liquid precursor and a propellent supply system.

Each reaction module is a cylindrical chamber comprising at least three sections: a heat generator section, a reactor section and a product formation chamber.

By changing the size of the sections, the residence time of the product in each zone is adjusted, and thus the installation to obtain a specific material is adjusted.

The material of the modules is for example high-temperature resistant steel, such as AISI 321, AISI 321H, S32100, S32109.

At the entrance to the section of the heat generator, a gas burner is installed. The gas burner is mounted on a removable cover, so that it is possible to clean the reaction zone from nanomaterial sinters.

As fuel for the burner, liquefied petroleum gas, natural gas, hydrogen, alcohols, gasoline or a mixture of these fuels can be used.

By changing the ratio between the fuel and the oxidizer, it is possible to achieve that the medium in the reactor will be either oxidizing or reducing as required by the conditions for the synthesis of a particular material.

In the reactor section there is a nozzle for entering the aerosol of the aqueous precursor solution. The nozzle is located at an angle of 45 degrees with respect to the reaction module. The length of the pipe is 1.5-2 diameter of the reaction zone.

The spray system comprises a mist-type two-phase nozzle with a spray cone angle of 30 degrees, a pump for pumping the liquid precursor and a propellent supply system (e.g. an air compressor or a tank with a liquefied inert gas).

As a propellent, either compressed air or inert gases (e.g. nitrogen, argon) are used. Regulation of the flow rate of the solution of the precursor is carried out by changing the pressure of the propellent and mortar at the entrance to the nozzle.

Control of the system is carried out by adjusting the flow of fuel gas and air-oxidizer in the burner, the pressure in the precursor tank, the pressure of compressed air at the inlet to the nozzle.

In the reactor, temperature and pressure control along the length of the reaction chamber is carried out, which allows adjusting the reagent flows to maintain the specified synthesis mode.

After passing through the reaction zone, the gas stream comprising the nanopowder in its volume enters the product formation chamber, whose task is to increase the residence time of the nanomaterial in the high temperature zone, and then into the nanomaterial collection system, which is a series of cyclones for collecting the largest fractions of the material (>10 μm), and bag and electrostatic filters for collecting nanoscale fractions.

The installation sprays the solution or suspension in the hot zone of the reactor at higher temperatures than it is performed by known systems in the range of 400-900° C. The aerosol is inserted to the flow of hot flue gas, where the evaporation of the solvent, the formation of particles of the precursor, the decomposition or chemical reaction of the particle precursor and the crystallization of powders is carried out.

The crystallization of nanopowders synthesized by the pyrolysis spray method, and requiring temperature treatment after synthesis, to achieve the desired degree of crystallinity, is achieved in one embodiment by a cyclone, the mode of operation of which is adjusted so that the particles entering the latter can circulate there as long as necessary, with large agglomerates of nanomaterial, are broken into smaller particles. Due to the high temperature of the gas flow coming from the reaction space of the nanomaterial synthesis plant in the cyclone, the high temperature necessary for the crystallization of nanoparticles is also maintained. Large particles, for one reason or another, not amenable to grinding remain in the cyclone and are removed through the lower nozzle of the apparatus.

The advantage of the present disclosure is in the increase of the efficiency of particle retention in the cyclone in the suspended state.

The method comprises steps of spraying a solution or suspension in the hot zone of the reactor at temperature range of 400-900° C., which is higher than known spray dryers. The aerosol is inserted into the flow of hot flue gas, where the evaporation of the solvent, particle formation, precursor and decomposition or chemical reaction of the particle precursor and the crystallization of powders is carried out.

Materials obtained according to an embodiment of the present method, for example LiFePO4, require additional heat treatment after synthesis up to 4 hours, at a temperature not lower than the temperature in the reaction zone.

The speed of gas supply to the cyclone in the operating mode is more than 25 m/s. This speed at the entrance to the cyclone is much higher than the operating speed of the gases at the entrance at which known cyclones operate.

More than 95% of the nanopowder with a particle size of up to 1 μm is found in this velocity range to be retained in the cyclone without settling on the walls, but not carried away by the gas flow through the upper part of the cyclone.

Operation in this mode allows to keep the nanoparticles in the cyclone for any length of time. Since the working area of the cyclone is constantly heated by a stream of gases coming out of the reaction module of the synthesis of nanoparticles, then this is suitable for long-term exposure of nanopowders at high temperatures, for crystallization of the latter.

According to an embodiment of the present method, the decrease in the velocity of gases at the entrance to the cyclone to 16-20 m/s leads to the transition of the installation in the classical cyclone mode, in which the deposition of nanomaterial in the cyclone and its subsequent collection is achieved.

In the speed range of 20-25 m/s, the unit operates in a mode that allows holding particles up to 3 microns in size. An increase in the flow rate at the entrance to the cyclone over 30 m/s does not lead to an increase in the efficiency of particle retention in the cyclone in the suspended state.

The collected material is collected at the bottom of the cyclone and discharged into the hopper receiving material.

In another embodiment of the present method part of the purified gas is returned to the entrance to the cyclone, while adjusting the width of the inlet gas flow rate is maintained at the entrance. Thus, the volume flow of gases at the entrance to the cyclone increases, which leads to the removal of larger particles to the filtration module.

By controlling the speed and volume flow of gas at the entrance to the cyclone, the retention in the cyclone of particles with a certain particle size distribution is achieved.

This unit effectively copes with the capture, retention and collection of nanoparticles larger than 1 μm. The particles in the process of being in the cyclone continuously interact with each other and the walls of the cyclone, grinding at the same time to a size at which the effective retention of particles in the cyclone becomes impossible, so the gas flow coming out of the cyclone-crystallizer should be sent to the filtration module providing a higher degree of collection of material with particle sizes less than 1 μm.

The ratio of the height of the cyclone to its maximum diameter in the range of 1.4:1-1.7:1. The optimal ratio of cyclone height to its maximum diameter is 1.6:1. The diameter of the cyclone is not more than 800 mm, but not less than 400 mm. The height of the cylindrical part of the cyclone 0.1-0.3 of the total height of the cyclone. The gas inlet pipe from the reaction module is located in the upper part of the cyclone tangentially.

In another embodiment, a method for thermal processing and grinding of nanopowders comprising steps of: spraying a solution in a zone of a reactor of a cyclone; carrying out evaporation of the solution, particle formation, precursor and decomposition or chemical reaction of the particle precursor and the crystallization of nanopowders.

The spraying is carried out at temperature range of 400-900° C. The solution is provided at the speed of between 16-30 m/s. The cyclone is constantly heated by a stream of gases coming out of the reaction module of the synthesis of nanopowder. The ratio of the height of the cyclone to its maximum diameter in the range of 1.4:1-1.7:1. The height of the cylindrical part of the cyclone is 0.1-0.3 of the total height of the cyclone. The gas inlet pipe from the reaction module is located in the upper part of the cyclone tangentially.

The device for crystallization of nanopowders synthesized by the spray pyrolysis method, and requiring temperature treatment after synthesis, to achieve the desired degree of crystallinity, is a cyclone, the mode of operation of which is adjusted so that the particles entering the latter can circulate there as long as necessary, with large agglomerates of nanomaterial, are broken into smaller particles. Due to the high temperature of the gas flow coming from the reaction space of the nanomaterial synthesis plant in the cyclone, the high temperature necessary for the crystallization of nanoparticles is also maintained. Large particles, for one reason or another, not amenable to grinding remain in the cyclone and are removed through the lower nozzle of the apparatus.

Installation for the production of nanopowders by spray pyrolysis, which has a modular system, each module of which is a cylindrical reactor, at the entrance to which a propane burner is installed, and at some distance from the entrance to the reactor there is a nozzle for entering the aerosol of the aqueous solution of the precursor. This aerosol enters the flow of hot flue gas, where the evaporation of the solvent, the formation of particles of the precursor, the decomposition or chemical reaction of the particle precursor and the crystallization of powders.

### DETAILED DESCRIPTION OF THE DRAWING

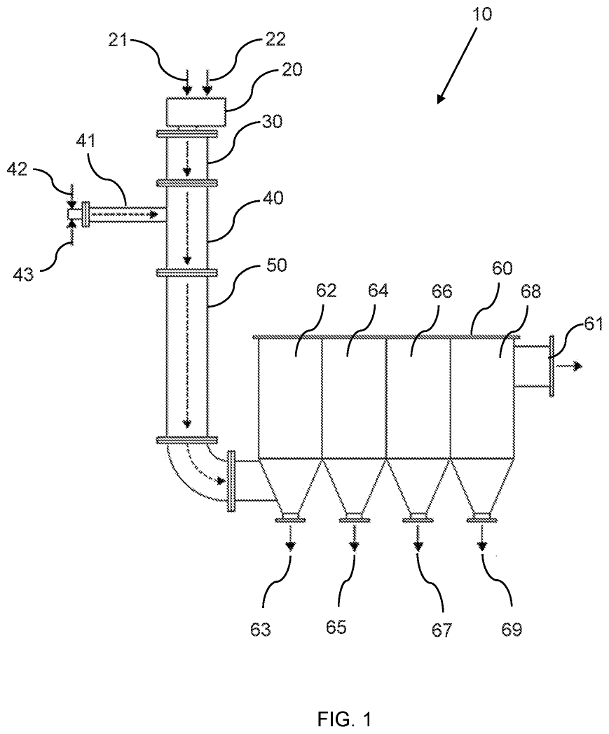

Referring to FIG. 1, there is shown a schematic illustration of an exemplary embodiment of an installation according to the present disclosure.

FIG. 1 is a schematic illustration of an exemplary embodiment of an assembly 10, also referred to as an apparatus or system, according to the present disclosure showing an industrial plant for the production of nanomaterial comprising a series of parallel operating reaction modules with a common gas outlet leading to the filtration system. The advantage of this embodiment is that it allows to use in installations of large capacity reaction modules, tested on a pilot industrial installations. Also, the reduction of the size of each reaction module facilitates assembling and maintenance of the system.

The assembly 10 according to the embodiment shown in FIG. 1 comprises a gas burner 20 having a fuel inlet 21 and a oxidant inlet 22; a cylindrical gas power generator 30 for heat generation, wherein the gas burner 20 is installed to the entrance of the gas power generator 30; a reactor section 40 is mounted or connected to the gas power generator 30 and comprises an aerosol generator 41 having liquid precursor inlet 42 and propellant inlet 43; a reactor section 50 for forming a product is connected to an end of the reactor section 40; a product formation chamber 60 for classification and collection of products connected to an end of the reactor section 50.

The product formation section 60 comprises an outlet 61 for treated gases and multiple chambers 62, 64, 66, 68 having outlets 63, 65, 67, 69 for the obtained nanomaterial according to the size of the particles of the obtained nanomaterials.

The fractions of the obtained nanomaterial are in the range of 10 mkm 10 nm, for example more than 10 mkm, less than 10 mkm, less than 1 mkm, less than 100 nm.

1. An apparatus for the production of nanopowders by spray pyrolysis, comprising:
a modular system having at least three reaction modules;
a propane burner installed at an entrance to a first one of the at least three reaction modules of the modular system; and
a spray system disposed at an entrance to a second one of the at least three reaction modules of the modular system, the spray system configured to insert an aerosol of the aqueous solution of the precursor.

2. The apparatus according to claim 1, wherein a reaction module is a cylindrical reactor.

3. The apparatus according to claim 1, wherein the modular system comprises at least a heat generator section, a reactor section and a product formation chamber.

4. The apparatus according to claim 1, wherein the spray system comprises a mist-type two-phase nozzle with a spray cone angle of 30 degrees a pump for pumping the liquid precursor and a propellent supply system.

5. The apparatus according to claim 4, wherein the nozzle is disposed at an angle of 45 degrees with respect to a reaction module of the modular system.

6. The apparatus according to claim 4, wherein a length of a pipe of the nozzle is 1.5-2 times a diameter of the reaction section.

7. A method for thermal processing and grinding of nanopowders comprising:
spraying a solution in a zone of a reactor of a cyclone;
carrying out evaporation of the solution, particle formation, precursor and decomposition or chemical reaction of the particle precursor and the crystallization of nanopowders.

8. The method according to claim 7, wherein the spraying is carried out at temperature range of 400-900° C.

9. The method according to claim 7, wherein the solution is provided at the speed of between 16-30 m/s.

10. The method according to claim 7, wherein the cyclone is constantly heated by a stream of gases coming out of a reaction module of the synthesis of nanopowder.

11. The method according to claim 7, wherein a ratio of a height of the cyclone to its maximum diameter is in a range of 1.4:1-1.7:1.

12. The method according to claim 7, wherein a height of a cylindrical part of the cyclone is 0.1-0.3 of a total height of the cyclone.

13. The method according to claim 7, wherein a gas inlet pipe from the reactor is located in an upper part of the cyclone tangentially.

14. The apparatus according to claim 1, wherein a third one of the at least three reaction modules comprises a product formation chamber, an inlet of the product formation chamber connected to a second end of the second one of the at least three reaction modules, the product formation chamber being configured to

15. An apparatus for the production of nanopowders by spray pyrolysis comprising:
a heat generator;
a reactor connected to an output of the heat generator; and
a product formation chamber coupled to an output of the reactor, the product formation chamber configured to receive a gas stream comprising the nanopowder from the reactor, increase a residence time of the nanopowder in a high temperature zone, and then into a nanomaterial collection system comprising a series of cyclones for collecting the largest fractions of the material and electrostatic filters for collecting nanoscale fractions.

16. The apparatus according to claim 15 further comprising a gas burner disposed at an entrance to the heat generator and a spray device disposed at an entrance to the reactor, the spray device configured to insert an aerosol of an aqueous solution of a precursor into the reactor.

17. The apparatus according to claim 16, wherein a nozzle of the spray device is disposed at an angle of 45 degrees with respect to the reactor.

18. The apparatus according to claim 16, the heat generator is configured to heat a hot zone of the reactor to a temperature in the range of 400 degrees Celsius to an including 900 degrees Celsius, and the spray device is configured to insert the aerosol of aqueous solution into a flow of hot flue gas in the hot zone of the reactor.

19. The apparatus according to claim 18, wherein the product formation chamber is configured to receive the flow of hot flue gas from the reactor at a speed of more than 25 m/s.

20. The apparatus according to claim 19, wherein the product formation chamber comprises at least one cyclone that is configured to retain and collect nanoparticles larger than a predetermined size and enable a gas flow of nanoparticles having a size less than the predetermined size out of the cyclone to a filtration module configured to collect the nanoparticles with the size less than the predetermined size.
